(19) United States
(12) Patent Application Publication
(10) Pub. No.: US 2022/0335410 A1
(43) Pub. Date: Oct. 20, 2022

(54) Payment Card with Phosphorescent Material

(71) Applicant: Capital One Services, LLC, McLean, VA (US)

(72) Inventors: Tyler Maiman, Melville, NY (US); Michael Saia, Walpole, MA (US); Phoebe Atkins, Rockville, VA (US)

(21) Appl. No.: 17/233,931

(22) Filed: Apr. 19, 2021

(51) Int. Cl. G06Q 20/34

(52) U.S. Cl. CPC G06Q 20/347; G06Q 20/357

(57) ABSTRACT

Aspects described herein may allow for a payment card having a first surface and an opposed second surface. A plurality of surface irregularities is formed on the first surface, with the plurality of surface irregularities defining alphanumeric characters. A phosphorescent coating is formed on at least a portion of the surface irregularities.

### FIELD OF USE

Aspects of the disclosure relate generally to a payment card with phosphorescent material. More specifically, aspects of the disclosure may provide a payment card having alphanumeric characters, and a phosphorescent coating formed on a surface of the alphanumeric characters.

### BACKGROUND

Individuals use payment cards such as credit cards, debit cards, ATM cards, medical insurance cards, membership cards, and other types of identification cards in many different environments. When the individual uses a payment card in a dark or low light environment, it may be hard for the user to read the information printed on the card. Differentiating between alphanumeric characters on the card with a color similar to that of the payment card itself can be challenging.

### SUMMARY

The following presents a simplified summary of various aspects described herein. This summary is not an extensive overview, and is not intended to identify key or critical elements or to delineate the scope of the claims. The following summary merely presents some concepts in a simplified form as an introductory prelude to the more detailed description provided below.

Aspects discussed herein may provide a payment card with a plurality of alphanumeric characters and a phosphorescent coating formed on a surface of the alphanumeric characters. Such a coating on the characters on the payment card may allow a user to more easily read the characters on the card, which can be particularly helpful in dark or low light environments, and for users whose vision is diminished.

In accordance with certain aspects, a payment card has a first surface and an opposed second surface. A plurality of surface irregularities is formed on the first surface, with the plurality of surface irregularities defining alphanumeric characters. A phosphorescent coating is formed on at least a portion of the surface irregularities.

In accordance with other aspects, a method of forming a payment card assembly includes forming a plurality of surface irregularities on a first surface of a payment card, with the plurality of surface irregularities defining alphanumeric characters, and depositing a phosphorescent coating on at least a portion of the surface irregularities.

In accordance with further aspects, a payment card has a first surface and an opposed second surface. A plurality of projections formed on the first surface define alphanumeric characters. A phosphorescent coating is formed on an outermost surface and a sidewall of each of the projections.

By using a payment card with a phosphorescent coating on a portion of alphanumeric characters on the card, individuals can more readily read the information provided on the card in environments where visibility is low. These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIG. 1 depicts a front view of a payment card implementing one or more aspects of the disclosure in accordance with one or more illustrative aspects discussed herein;

FIG. 2 depicts a rear view of the payment card of FIG. 1;

FIG. 3 depicts a section view of a portion of one embodiment of the payment card of FIG. 1;

FIG. 4 depicts a section view of a portion of an alternative embodiment of the payment card of FIG. 1;

FIG. 5 depicts a section view of a portion of another alternative embodiment of the payment card of FIG. 1;

FIG. 6 depicts a section view of a portion of a further alternative embodiment of the payment card of FIG. 1;

FIG. 7 depicts a section view of a portion of yet another alternative embodiment of the payment card of FIG. 1;

FIG. 8 depicts a section view of a portion of a further alternative embodiment of the payment card of FIG. 1

FIG. 9 depicts a section view of a portion of a further alternative embodiment of the payment card of FIG. 1; and

FIG. 10 depicts a section view of a portion of an additional alternative embodiment of the payment card of FIG. 1.

### DETAILED DESCRIPTION

In the following description of the various embodiments, reference is made to the accompanying drawings, which form a part hereof, and in which is shown by way of illustration various embodiments in which aspects of the disclosure may be practiced. It is to be understood that other embodiments may be utilized and structural and functional modifications may be made without departing from the scope of the present disclosure. Aspects of the disclosure are capable of other embodiments and of being practiced or being carried out in various ways. Also, it is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof.

By way of introduction, aspects discussed herein may relate to apparatuses and methods for providing a phosphorescent coating on a portion of a payment card of user.

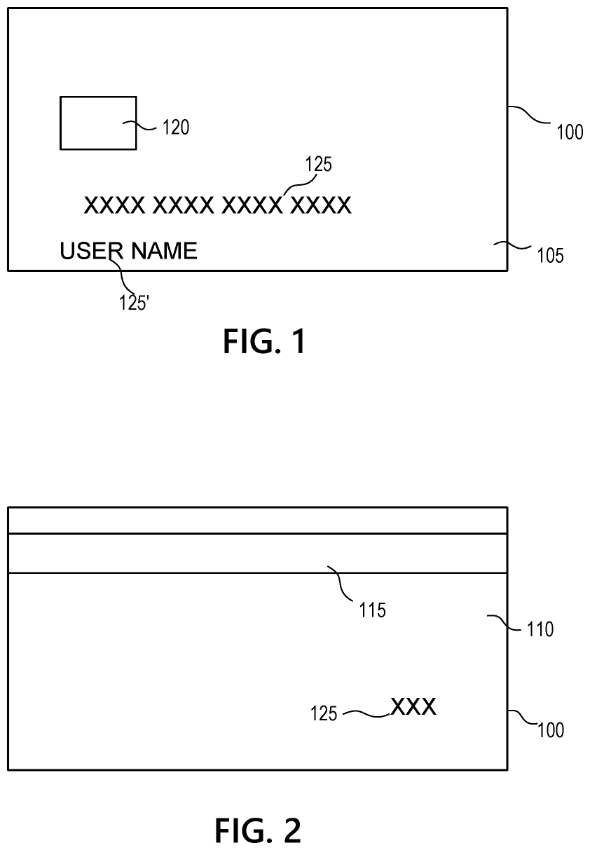

An illustrative embodiment of a payment card 100 is illustrated in FIGS. 1-2. It is to be appreciated that payment card 100 could be a credit card, a debit card, an ATM card, or a money access card (“MAC”), for example. In other embodiments, payment card 100 could be a medical insurance card, or a membership card, for example. In the illustrated embodiment, payment card 100 is a credit card having a first surface 105 and an opposed second surface 110. A Europay Mastercard Visa (“EMV”) chip 120 may be positioned on first surface 105 of payment card 100. A magnetic strip 115 may be positioned on second surface 110 of payment card 100.

First surface 105 may also include a plurality of alphanumeric characters 125. In such an embodiment, alphanumeric characters 125 may form a credit card number on first surface 105 of payment card 100. In certain embodiments, a second set of alphanumeric characters 125′ on first surface 105 of payment card 100 could form a user's name. In certain embodiments, a plurality of alphanumeric characters 125 could also be provided on second surface 110 of payment card 100, and these alphanumeric characters 125 could form a security code for payment card 100, for example.

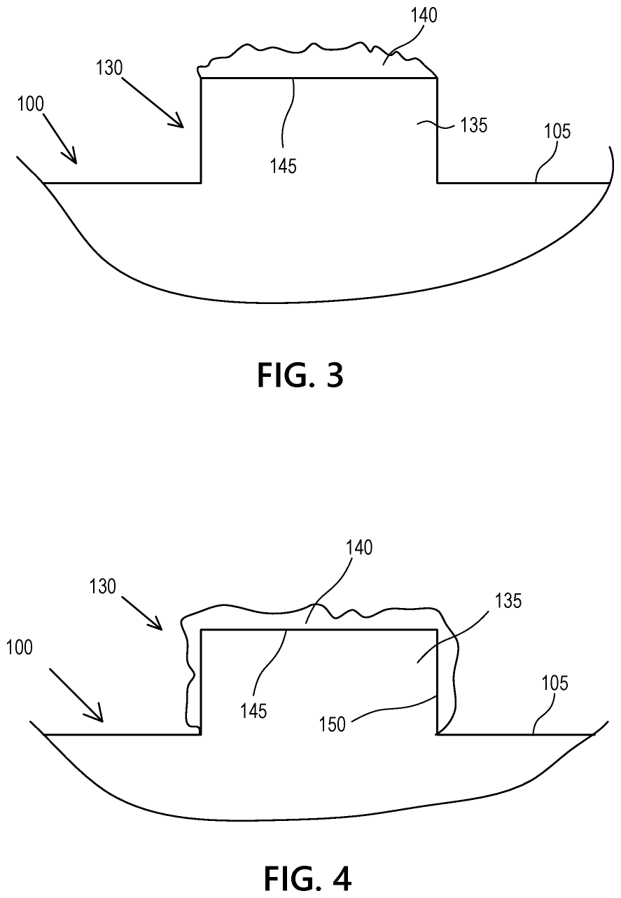

In certain embodiments, as illustrated in FIGS. 3-4, a plurality of surface irregularities 130 may be formed on first surface 105 and define alphanumeric characters 125. Surface irregularities 130 may be raised or recessed with respect to first surface 105 of payment card 100. In the embodiment illustrated here, surface irregularities 130 may take the form of projections 135 extending outwardly from first surface 105.

A phosphorescent coating 140 may be formed on at least a portion of each surface irregularity 130, such as projections 135. When the material of the phosphorescent coating 140 is in the presence of a light source, such as during the daytime, it may absorb radiation from the light source. When phosphorescent coating 140 is in a dark environment or a low light setting, such as during the evening or at night, it may glow, and thereby increase the visibility of the portion of projection 135 on which phosphorescent coating 140 is formed. Thus, when an individual is attempting to read alphanumeric characters 125 in a dark environment, such as in a dimly lit restaurant, for example, the glowing light from phosphorescent coating 140 may improve the visibility of alphanumeric characters 125.

In the embodiment illustrated in FIG. 3, phosphorescent coating 140 is formed on an outermost surface 145 of each projection 135. In other embodiments, as illustrated in FIG. 4, phosphorescent coating 140 may also be formed on a sidewall 150 of each projection 135, providing additional visibility for alphanumeric characters 125 from the side, and at an angle with respect to first surface 105, thereby enhancing the user's ability to see alphanumeric characters 125 in low light settings.

It is to be appreciated that projections 135 can be formed in various ways. For example, projections 135 can be formed by embossing payment card 100, or they may be formed as part of a molding process used to form payment card 100. Other means or forming projections 135 on payment card 100 will become readily apparent to those skilled in the art, given the benefit of this disclosure.

Thus, for example, a method of forming a payment card assembly could include forming surface irregularities 135 on first surface 105 of payment card 100, with surface irregularities 130 defining alphanumeric characters 125, and depositing phosphorescent coating 140 on at least a portion of each surface irregularity 130.

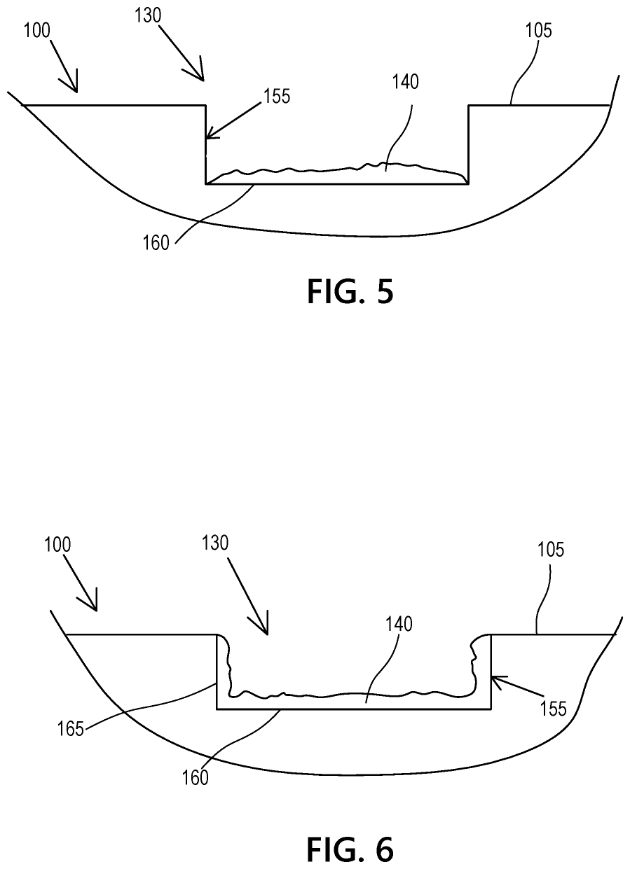

In other embodiments, as illustrated in FIGS. 5-6, each surface irregularity 130 may take the form of a recess 155 formed in first surface 105. In the embodiment illustrated in FIG. 5, phosphorescent coating 140 may be formed on an innermost surface 160 of each recess 155. In other embodiments, as illustrated in FIG. 6, phosphorescent coating 140 may also be formed on a sidewall 165 of each recess 155, providing additional visibility for alphanumeric characters 125 from the side, and at an angle with respect to first surface 105, thereby enhancing the user's ability to see alphanumeric characters 125 in low light settings.

It is to be appreciated that recesses 155 can be formed in various ways. For example, recesses 155 can be formed by embossing payment card 100, or by milling first surface 105 of payment card 100, or with the use of a laser, for example. Other means or forming recesses 155 in payment card 100 will become readily apparent to those skilled in the art, given the benefit of this disclosure.

In the embodiments illustrated in FIGS. 3-4, surface irregularities 130 are shown as defining alphanumeric characters 125 on first surface 105 of payment card 100, which could be, for example, an account number for payment card 100. It is to be appreciated that surface irregularities 130 could also be provided on second surface 110 of payment card 100 to define additional alphanumeric characters 125, which could be, for example, a security code for payment card 100.

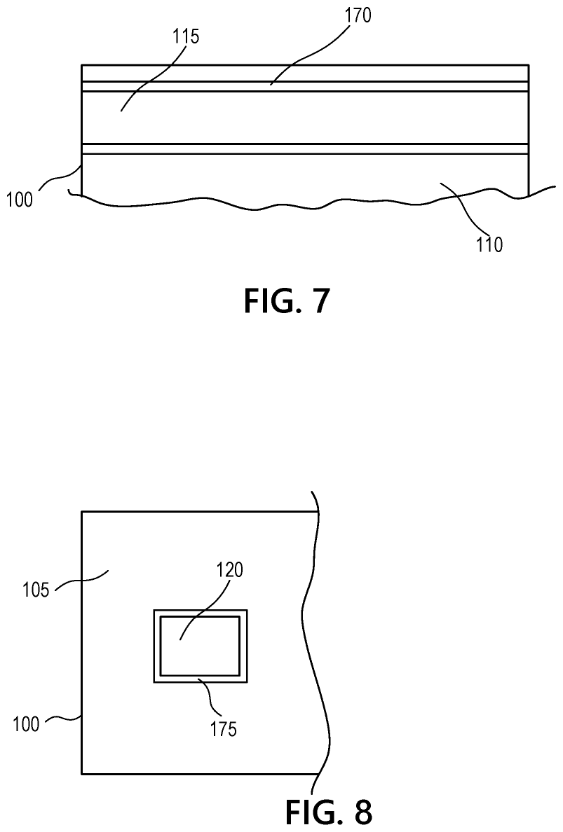

It is to be appreciated that phosphorescent coating 140 could be applied to other elements of payment card 100. For example, phosphorescent coating 140 could be applied to magnetic strip 115, which would allow the user to more clearly see magnetic strip 115 in low light environments. In other embodiments, as illustrated in FIG. 7, surface irregularities 130 could define a border 170 surrounding magnetic strip 115, with phosphorescent coating 140 being applied to border 170, as described above, thereby helping the user more easily find magnetic strip 115 on payment card 100 in low light environments.

Similarly, in other embodiments, phosphorescent coating 140 could be applied to EMV chip 120, which would allow the user to more clearly see EMV chip 120 in low light environments. In other embodiments, as illustrated in FIG. 8, surface irregularities 130 could define a border 175 surrounding EMV chip 120, with phosphorescent coating 140 being applied to border 175, as described above, thereby helping the user more easily find EMV chip 120 on payment card 100 in low light environments.

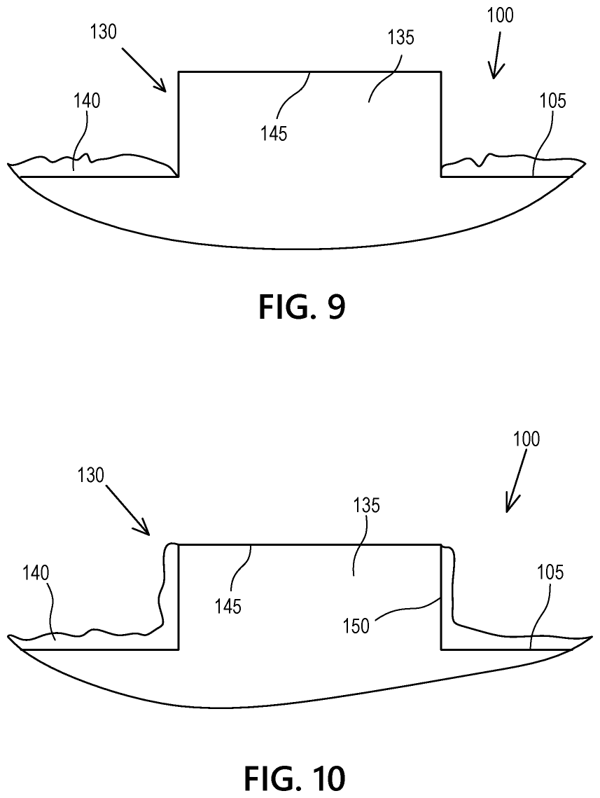

In certain embodiments, as illustrated in FIG. 9, phosphorescent coating 140 could be applied to the areas of payment card 10 outside of surface irregularities 130. In such an embodiment, phosphorescent coating 140 could be applied, for example, to all of first side 105 of payment card 10, but not to sidewall 150 or outermost surface 145 of each projection 135. Thus, in such an embodiment, when the user views such a payment card 10 in a low light environment, most of the card would glow due to phosphorescent coating 140, while surface irregularities 130 would remain dark, thereby allowing the user to easily read alphanumeric characters 125 defined by surface irregularities 130.

In other embodiments, as illustrated in FIG. 10, phosphorescent coating 140 could be applied to both all of first side 105 of payment card 10 and to sidewall 150 of each projection 135, but not to outermost surface 145 of each projection 135. As with the embodiment discussed above with respect to FIG. 9, when the user views such a payment card 10 in a low light environment, most of the card would glow due to phosphorescent coating 140, while surface irregularities 130 would remain dark, thereby allowing the user to easily read alphanumeric characters 125 defined by surface irregularities 130.

It is to be appreciated that in the embodiments described above with respect to FIGS. 9-10, phosphorescent coating 140 may also not be applied to magnetic strip 115 and/or EMV chip 120, or to their respective borders 170, 175.

It is to be appreciated that phosphorescent coating 140 may be applied to surface irregularities 130 or other elements of payment card 100 in a variety of ways. For example, phosphorescent coating 140 may be applied to a portion of each surface irregularity 130 or other elements of payment card 100 by pad printing. In other embodiments, phosphorescent coating 140 may be applied to a portion of each surface irregularity 130 or other elements of payment card 100 by drop on demand printing. Other means or applying phosphorescent coating 140 to portions of payment card 100 will become readily apparent to those skilled in the art, given the benefit of this disclosure.

By having a phosphorescent coating applied to portions of alphanumeric characters, or other elements of a payment card, the user can more easily read information printed on the payment card, such as an account number, or identify elements on the payment card, such as a magnetic strip or an EMV chip, in a dark or low light environment.

Various embodiments of a payment card assembly with a phosphorescent coating may include various components and features. In different embodiments, the payment card assembly may be provided with any combination of such components and features. It is also understood that in other embodiments, the various devices, components, and features of the payment card assembly described herein may be constructed with similar structural and functional elements having different configurations, including different ornamental appearances.

Those having skill in the art, with the knowledge gained from the present disclosure, will recognize that various changes can be made to the disclosed apparatuses and methods in attaining these and other advantages, without departing from the scope of the present disclosure. As such, it should be understood that the features described herein are susceptible to modification, alteration, changes, or substitution. For example, it is expressly intended that all combinations of those elements and/or steps which perform substantially the same function, in substantially the same way, to achieve the same results are within the scope of the embodiments described herein. Substitutions of elements from one described embodiment to another are also fully intended and contemplated. The specific embodiments illustrated and described herein are for illustrative purposes only, and not limiting of that which is set forth in the appended claims. Other embodiments will be evident to those of skill in the art. It should be understood that the foregoing description is provided for clarity only and is merely exemplary

1. A payment card assembly comprising:
a payment card having a first surface and an opposed second surface;
a first plurality of surface irregularities formed on the first surface, the first plurality of surface irregularities defining alphanumeric characters;
an EMV chip positioned on the first surface of the payment card spaced from the first plurality of surface irregularities;
a second plurality of surface irregularities formed on the first surface of the payment card and spaced from the first plurality of surface irregularities, the second plurality of surface irregularities defining a border surrounding the EMV chip; and
a phosphorescent coating formed on at least a portion of the first plurality of surface irregularities, and on at least a portion of the second plurality of surface irregularities defining the border surrounding the EMV chip, wherein the phosphorescent coating is visible in low light environments.

2. The payment card assembly of claim 1, wherein the first plurality of surface irregularities are formed as projections extending outwardly from the first surface.

3. The payment card assembly of claim 2, wherein the phosphorescent coating is formed on an outermost surface of each projection.

4. The payment card assembly of claim 3, wherein the phosphorescent coating is formed on a sidewall of each projection.

5. The payment card assembly of claim 1, wherein the first plurality of surface irregularities are formed as recesses in the first surface.

6. The payment card assembly of claim 5, wherein the phosphorescent coating is formed on an innermost surface of each recess.

7. The payment card assembly of claim 6, wherein the phosphorescent coating is formed on a sidewall of each recess.

8-19. (canceled)

20. A payment card assembly comprising:
a payment card having a first surface and an opposed second surface;
an EMV chip positioned on the first surface of the payment card;
a plurality of recesses formed on the first surface, the recesses defining a border surrounding the EMV chip; and
a phosphorescent coating formed on an innermost surface and a sidewall of each of the recesses, wherein the phosphorescent coating is visible in low light environments.

21. The payment card assembly of claim 1, wherein the second plurality of surface irregularities are formed as recesses in the first surface.

22. The payment card assembly of claim 21, wherein the phosphorescent coating is formed on an innermost surface of each recess.

23. The payment card assembly of claim 22, wherein the phosphorescent coating is formed on a sidewall of each recess.

24. The payment card assembly of claim 1, wherein the second plurality of surface irregularities are formed as projections extending outwardly from the first surface.

25. The payment card assembly of claim 24, wherein the phosphorescent coating is formed on an outermost surface of each projection.

26. The payment card assembly of claim 25, wherein the phosphorescent coating is formed on a sidewall of each projection.

27. The payment card assembly of claim 1, further comprising:
a magnetic strip positioned on the second surface of the payment card;
a third plurality of surface irregularities formed on the second surface of the payment card to define a border surrounding the magnetic strip; and
a phosphorescent coating formed on at least a portion of the first plurality of surface irregularities, and on at least a portion of the third plurality of surface irregularities surrounding the magnetic strip,
wherein the phosphorescent coating is formed on at least a portion of the third plurality of surface irregularities surrounding the magnetic strip.

28. The payment card assembly of claim 1, further comprising:
a magnetic strip positioned on the second surface of the payment card,
wherein the phosphorescent coating is also formed on the magnetic strip.

29. A payment card assembly comprising:
a payment card having a first surface and an opposed second surface;
a first plurality of surface irregularities formed on the first surface, the first plurality of surface irregularities defining alphanumeric characters;
a magnetic strip positioned on the second surface of the payment card;
a second plurality of surface irregularities formed on the second surface of the payment card, the second plurality of surface irregularities defining a border surrounding the magnetic strip; and
a phosphorescent coating formed on at least a portion of the first plurality of surface irregularities, and on at least a portion of the second plurality of surface irregularities on the second surface surrounding the magnetic strip, wherein the phosphorescent coating is visible in low light environments.

30. The payment card assembly of claim 29, wherein the second plurality of surface irregularities are formed as recesses in the first surface.

31. The payment card assembly of claim 30, wherein the phosphorescent coating is formed on an innermost surface of each recess.

32. The payment card assembly of claim 31, wherein the phosphorescent coating is formed on a sidewall of each recess.
